(19) United States
(12) Patent Application Publication
(10) Pub. No.: US 2025/0301314 A1
(43) Pub. Date: Sep. 25, 2025

(54) Methods And Apparatus Of Security Key Derivation For Layer 1/Layer 2 Triggered Mobility In Mobile Communications

(71) Applicant: MediaTek Singapore Pte. Ltd., Singapore (SG)

(72) Inventor: Xiaonan Zhang, Beijing (CN)

(21) Appl. No.: 19/084,615

(22) Filed: Mar. 19, 2025

(30) Foreign Application Priority Data
Mar. 22, 2024 (WO) PCT/CN2024/083272
Mar. 7, 2025 (CN) 202510275860.4

(51) Int. Cl. H04W 12/041

(52) U.S. Cl. CPC H04W 12/041

(57) ABSTRACT

Various solutions for security key derivation for layer 1/layer 2 triggered mobility (LTM) in mobile communications are described. A user equipment (UE) may receive security key update information from a network node during an LTM procedure. The UE may derive a security key for a target cell based on the security key update information. Also, the UE may perform an LTM cell switch to switch to the target cell. Furthermore, the UE may transmit a message encrypted with the security key to the target cell. Accordingly, the dynamic vertical security key update for LTM can be supported.

### CROSS REFERENCE TO RELATED PATENT APPLICATION(S)

The present disclosure is part of a non-provisional application claiming the priority benefit of PCT Application No. PCT/CN2024/083272, filed 22 Mar. 2024, and CN Application No. 202510275860.4, filed 7 Mar. 2025. The contents of aforementioned applications are herein incorporated by reference in their entirety.

### TECHNICAL FIELD

The present disclosure is generally related to mobile communications and, more particularly, to security key derivation for layer 1/layer 2 triggered mobility (LTM) with respect to user equipment and network apparatus in mobile communications.

### BACKGROUND

Unless otherwise indicated herein, approaches described in this section are not prior art to the claims listed below and are not admitted as prior art by inclusion in this section.

In mobile communications, handover refers a process of transferring an ongoing communication session of a user equipment (UE) from one cell to another in connected state, such that seamless connectivity and continuity of service for the user can be ensured, especially when the user is on the move. In legacy handover (e.g., a type of cell switch) specified in 3^{rd} Generation Partnership Project (3GPP) Release 17, a serving cell switch is triggered by layer 3 (L3) measurements with radio resource control (RRC) signaling for switching from a serving cell to a target cell. This L3 based mobility involves reconfiguration of upper layers (e.g., RRC layer and/or packet data convergence protocol (PDCP) layer) and resetting of lower layers (e.g., medium access control (MAC) layer and/or physical (PHY) layer), which inevitably leads to long latency, large signaling overhead, and long interruption time. Advanced to Release 18, a lower layer triggered mobility (also called layer 1 (L1)/layer 2 (L2) triggered mobility, LTM) is introduced to enable the cell switch procedure via L1 or L2 signaling, which can keep configuration of the upper layers and/or minimize changes of configuration of the lower layers for reducing latency during the cell switch procedure.

In an LTM procedure, LTM preparation and early synchronization are performed prior to LTM cell switch execution. When the condition is met, a cell switch command is indicated to UE to trigger the cell switch procedure. During the preparation stage, configurations toward candidate cells are pre-configured by an RRC message. However, as the current L1/L2 based inter-central unit (CU) mobility does not support security update, there is a need to develop solutions for the corresponding procedure.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to security key derivation for layer 1/layer 2 triggered mobility (LTM) with respect to user equipment (UE) and network apparatus in mobile communications.

In one aspect, a method may involve an apparatus receiving a security key update information from a network node during an LTM procedure. The method may also involve the apparatus deriving a security key for a target cell based on the security key update information. The method may further involve the apparatus performing an LTM cell switch to switch to the target cell. Furthermore, the method may involve the apparatus transmitting a message encrypted with the security key to the target cell.

In one aspect, an apparatus may comprise a transceiver which, during operation, wirelessly communicates with a network. The apparatus may also comprise a processor communicatively coupled to the transceiver. The processor, during operation, may perform operations comprising receiving, via the transceiver, a security key update information from a network node during an LTM procedure. The processor may also perform operations comprising deriving a security key for a target cell based on the security key update information. The processor may also perform operations comprising performing an LTM cell switch to switch to the target cell. The processor may further perform operations comprising transmitting, via the transceiver, a message encrypted with the security key to the target cell.

In another aspect, a method may involve a network node determining at least one candidate cell for a UE. The method may also involve the network node transmitting a security key update information to the UE during an LTM procedure for a security key derivation associated with the at least one candidate cell.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with implementations of the present disclosure.

FIG. 2 is a diagram depicting an example scenario of inter-central unit (CU) layer 1/layer 2 triggered mobility (LTM) in accordance with implementations of the present disclosure.

FIG. 3 is a diagram depicting an example scenario of security key derivation in accordance with an implementation of the present disclosure.

FIG. 4 is a diagram depicting another example scenario of security key derivation in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to security key derivation for layer 1/layer 2 triggered mobility (LTM) in mobile communications. According to the present disclosure, a number of possible solutions may be implemented separately or jointly. That is, although these possible solutions may be described below separately, two or more of these possible solutions may be implemented in one combination or another.

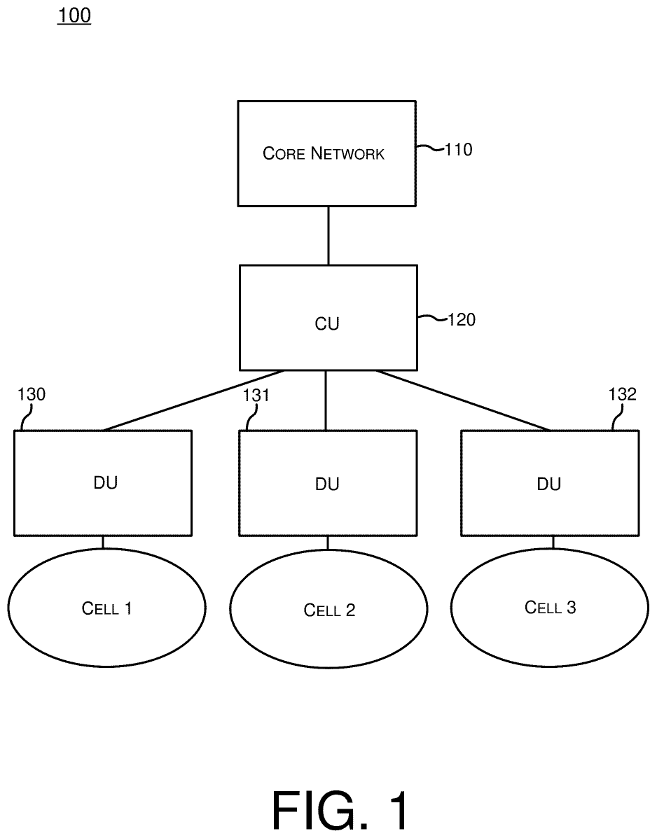

FIG. 1 illustrates an example mobile communication network 100 in accordance with an implementation of the present disclosure. As shown in FIG. 1, the mobile communication network 100 supports various wireless communication services and may be functionally operated with different protocol split options among at least a core network 110 and a plurality of base stations (BSs), e.g., evolved NodeBs (eNBs), next generation NodeBs (gNBs), or transmission and reception points (TRPs). In some implementations, the plurality of BSs may be gNBs implemented as a central unit (CU) 120 and distributed units (DUs) 130-132 associated with serving coverages/cells (e.g., Cells 1-3). In some implementations, service data application protocol (SDAP) and packet data convergence protocol (PDCP) layers may be located in the CU 120, and radio link control (RLC), medium access control (MAC) and physical (PHY) layers may be located in the DUs 130-132.

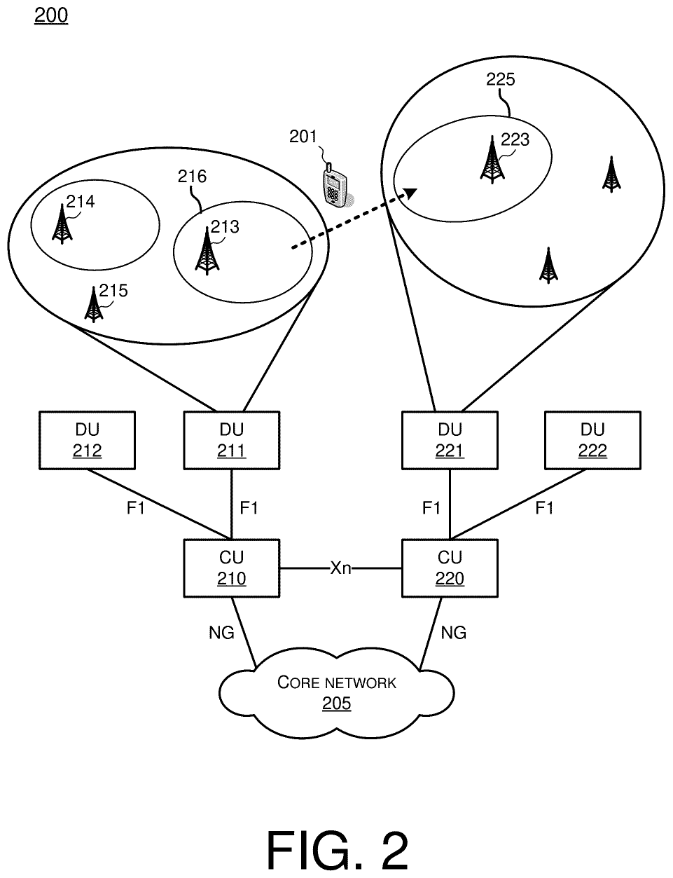

FIG. 2 is a diagram depicting an example scenario of inter-CU LTM in accordance with implementations of the present disclosure. As shown in FIG. 2, the CUS 210 and 220 are connected to a core network 205 through a next generation (NG) interface. The CUs 210 and 220 are connected to each other through an Xn interface. In scenario 200, each of the CUs 210 and 220 is connected to two DUs through an F1 interface, and each DU is connected to multiple radio units (RUs), respectively. A cell may consist of a range covered by one or more RUs under the same DU. For example, the CU 210 is connected to the DUs 211 and 212, the DU 211 is connected to the RUs 213, 214, and 215, and the cell 216 consists of a range covered by the RU 213.

In scenario 200, a UE 201 may move from the edge of one cell to another cell, in which the source cell and the target cell may belong to different CUs. For example, the UE 201 is moving from the cell 216 belong to the CU 210 to a cell 225 belong to the CU 220. The protocol stack including PDCP, RLC, and MAC are different in the CUS 210 and 220 and corresponding DUs 211 and 221. An inter-CU LTM procedure may be used in scenario 200 to reduce the interruption and improve the throughput of the UE 201. In one embodiment, a dynamic vertical security key derivation may be supported during the inter-CU LTM procedure.

To be specific, the UE 201 may receive a security key update information from the BS associated with the RU 213 during the inter-CU LTM procedure. In one embodiment, the security key update information is received during an LTM preparation stage of the inter-CU LTM procedure. For example, the security key update information may be carried by a radio resource control (RRC) message (e.g., an RRCReconfiguration message specifying the LTM candidate configuration). In another embodiment, the security key update information may be received during an LTM cell switch execution stage. For instance, the security key update information may be carried by an LTM cell switch command, which may be carried by an MAC-control element (CE) message. In yet another embodiment, the security key update information may be received before the UE 201 receives the LTM cell switch command. For example, the security key update information is carried by an MAC-CE message different from the LTM cell switch command, or alternatively, the security key update information is indicated by a downlink control information (DCI) format. In still another embodiment, the security key update information may be indicated by messages received in the same or different stages of the inter-CU LTM procedure. For example, the security key update information may be indicated by a combination of an RRC message received in the LTM preparation stage and an LTM cell switch command received in the LTM cell switch execution stage. The security key update information may include one or more next hop chaining counter (NCC) values or NCC associated information associated with the LTM candidate cell(s). Furthermore, according to one embodiment, the security key update information is for the current LTM cell switch indicated by the LTM cell switch command. According to the security key update information, the UE 201 may determine whether to perform a vertical key derivation process or a horizontal key derivation process for the target cell of the current LTM cell switch. In another embodiment, the security key update information is for the next LTM cell switch. Based on the security key update information, the UE 201 may perform the vertical or horizontal key derivation process for the target cell of the next LTM cell switch in advance.

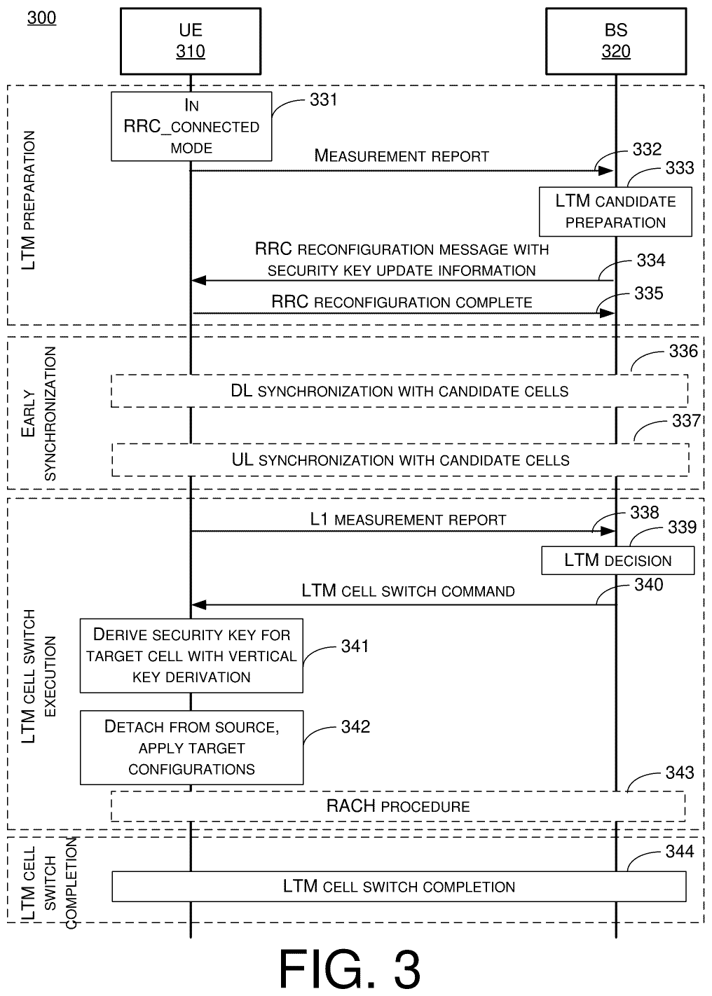

FIG. 3 is a diagram depicting an example scenario of security key derivation in accordance with an implementation of the present disclosure. In inter-CU LTM procedure 300, the UE 310 receives the security key update information during the LTM preparation stage. To be specific, as shown in operations 331 to 333, the UE 310 in an RRC connected mode may send the measurement report to the BS 320, and the BS 320 decides to configure LTM (e.g., determining one or more LTM candidate cells for the UE310). In operation 334, the BS 320 transmits an RRC reconfiguration message to the UE 310 including the LTM candidate configurations and the security key update information. In one example, the security key update information may include one or more NCC values for the candidate cell(s). Alternatively, the security key update information may include NCC associated information for the candidate cell(s). In operation 335, the UE 310 stores the LTM candidate configurations and the security key update information and transmits an RRC reconfiguration complete message to the BS 320. The UE 310 may store the identifier of all candidate cell(s) for future security key update. Then during the early synchronization stage as shown in operations 336 and 337, the UE 310 performs a downlink (DL) synchronization and an uplink (UL) synchronization with the candidate cell(s).

During the LTM cell switch execution stage, as show in operations 338 to 340, the UE 310 may perform L1 measurements on the candidate cell(s) and transmit the L1 measurement reports to the BS 320. The BS 320 then decides to execute cell switch to a target cell and transmits an LTM cell switch command MAC-CE to the UE 310. In operation 341, the UE 310 derives the security key for the target cell based on the security key update information received in operation 334 and a target cell identifier (ID) included in the LTM cell switch command MAC-CE. For example, according to the security key update information included in the indication for the current LTM cell switch, the UE 310 may perform a vertical key derivation process to derive the security key for the target cell. As shown in operations 342 and 343, the UE 310 switches to the target cell, applies the configuration associated with the target cell, and performs a random access channel (RACH) procedure towards the target cell.

Finally, in the LTM cell switch completion stage, the UE 310 completes the LTM cell switch procedure by sending an RRC reconfiguration complete message to the target cell as shown in operation 344. To be specific, the RRC reconfiguration complete message is encrypted with the security key for the target cell derived in operation 341.

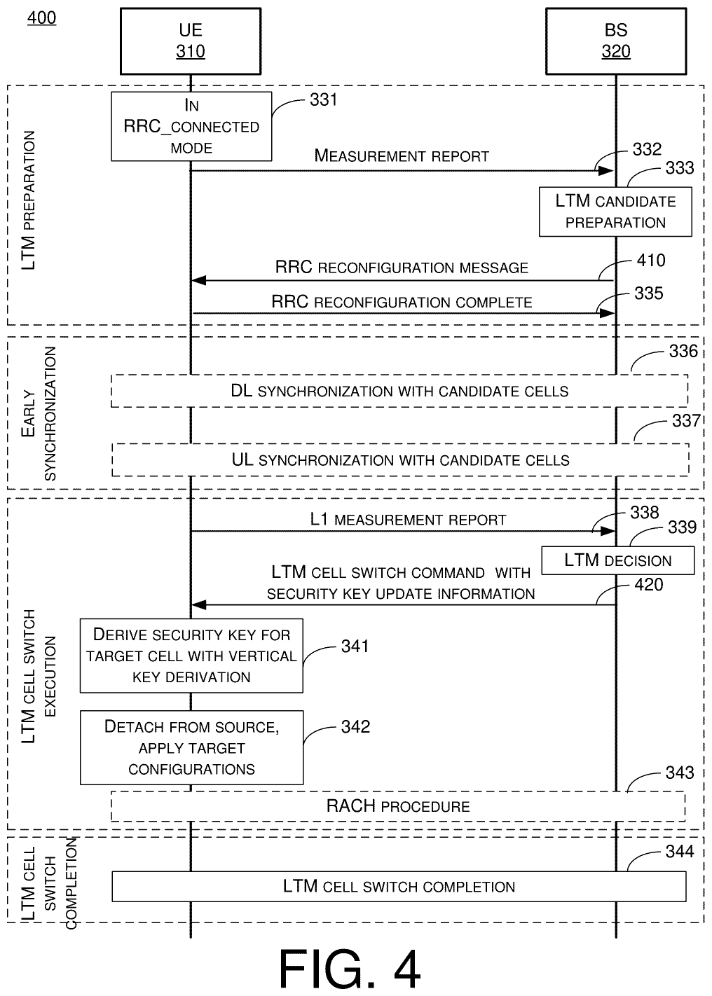

FIG. 4 is a diagram depicting another example scenario of security key derivation in accordance with an implementation of the present disclosure. In inter-CU LTM procedure 400, the security key update information is received during the LTM cell switch execution stage. As shown in operation 410, the RRC reconfiguration message from the BS 320 may include the LTM candidate configurations. The security key update information is included in the LTM cell switch command as shown in operation 420. Operations in FIG. 4 with the same labels as those shown in FIG. 3 may be the same or similar, and thus the detailed descriptions are omitted here.

In the foregoing embodiments, the way to perform the vertical key derivation process may be associated with the content of security key update information delivered by one or a combination of the LTM candidate configuration message, the LTM cell switch command MAC-CE, and a new message received before the LTM cell switch execution. In one embodiment, when the security key update information includes the explicit NCC value(s) of the candidate cell(s), the security key for the target cell may be derived based on the NCC value and the target cell ID. For example, a next hop (NH) value is first derived based on the NCC value of the target cell included in the security key update information, then the security key is derived based on the NH value and the target cell ID. In another embodiment, the NCC value is not directly provided to the UE (e.g., due to security concerns). Instead, the BS provides NCC associated information to the UE as the security key update information. The NCC associated information may be an NCC increment indicator, the difference between the new NCC value and the previous NCC, or a parameter for a specific formula to derive the NCC value. The NCC value of the target cell is first derived based on the NCC associated information. Subsequently, the security key for the target cell is derived based on the derived NCC value and the target cell ID. For instance, an NH value is derived based on the derived NCC value, and then the security key is derived based on the NH value and the target cell ID. In one example, the new NCC value for the target cell may be determined by incrementing the previous NCC value by a specific value (e.g., 1). This increment is indicated by the NCC increment indicator. Specifically, the UE may be preconfigured with a list of increment values. When performing the vertical key derivation process, one of these increment values is selected to increase the previous NCC value based on the NCC increment indicator. In another example, the new NCC value for the target cell may be equal to the previous NCC value plus a difference between the new NCC value and the previous NCC value, the difference is indicated by the security key update information. In yet another example, the new NCC value for the target cell may be derived using a specific formula. This formula takes a parameter indicated by the security key update information and the previous NCC value as inputs. In the foregoing examples, the previous NCC value is maintained by the UE, which may be the NCC value of the current serving cell, or the NCC value of the target cell for the last LTM cell switch. The formula is maintained by the UE and the core network (e.g., the access and mobility management function (AMF)). In yet another embodiment, when the security key update information is delivered by two or more messages, the UE may first determine the NCC value for the target cell based on those messages, then derive the security key for the target cell. For example, a list of NCC values is preconfigured by an LTM candidate configuration message, and an index for NCC value selection is indicated by the LTM cell switch command MAC-CE. The UE may derive the NCC value for the target cell according to the LTM candidate configuration message and the LTM cell switch command MAC-CE, then derive the security key for the target cell.

In one embodiment, if the security key update information for the vertical key derivation process is absent, the UE may perform a horizontal key derivation process to derive the security key for the target cell. For example, during a particular stage of the LTM procedure, the UE may expect to receive one or more specific messages carrying the security key update information for the vertical key derivation process. If the UE does not receive such a message or if an indication for the current LTM cell switch in the message indicates that the vertical key derivation process should not be performed, the UE may perform the horizontal key derivation process for the target cell.

In one embodiment, the security key for the target cell or any intermediated data (e.g., the new derived NCC value and/or the NH value) generated during the vertical and/or horizontal key derivation process may be stored for future security key update. Furthermore, the UE may be indicated to perform another LTM cell switch by a subsequent LTM cell switch command MAC CE. In one example, the UE may perform the horizontal or vertical key derivation process according to an indication comprising the security key update information for the next LTM cell switch from the network and perform the same behavior in the LTM cell switch execution stage and the LTM cell switch completion stage as described above. For example, it is assumed that the UE may switch from cell A to cell B for the current LTM cell switch and may switch from cell B to cell C for the next LTM cell switch. During the LTM preparation stage or the LTM cell switch execution stage of the LTM procedure for switching from cell A to cell B, the UE may receive security key update information for the next LTM cell switch. The UE may derive the security key for cell C, the target cell for the next LTM cell switch, during the current LTM procedure by performing the vertical or horizontal key derivation process based on the security key update information for the next LTM cell switch. Therefore, latency is reduced by deriving the security key in advance.

### Illustrative Implementations

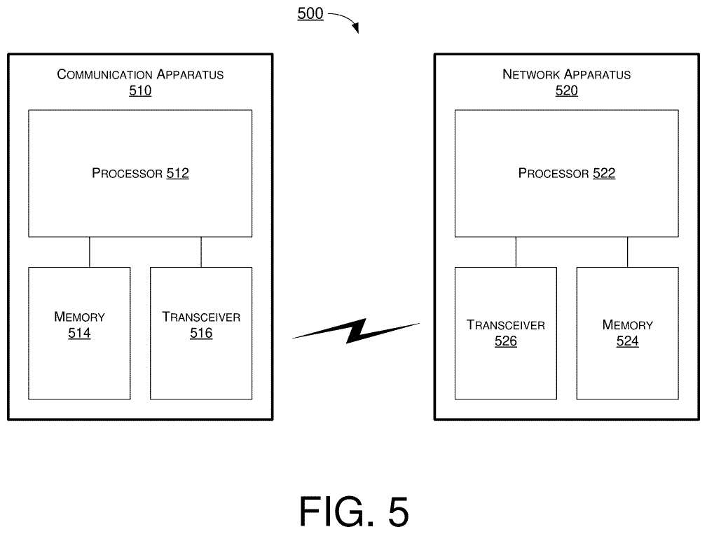

FIG. 5 illustrates an example communication system 500 having at least an example communication apparatus 510 and an example network apparatus 520 in accordance with an implementation of the present disclosure. Each of the communication apparatus 510 and network apparatus 520 may perform various functions to implement schemes, techniques, processes and methods described herein pertaining to security key derivation for LTM in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNB in an LTE network, in a gNB in a 5G/NR, IoT, NB-IoT or IIoT network or in a satellite or base station in a 6G network. Network apparatus 520 may include at least some of those components shown in FIG. 5 such as a processor 522, for example. Processor 522 may further include protocol stacks and a set of control functional modules and circuits. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of the processor 512 and processor 522 may be implemented in the form of one or more single-core processors, one or more multi-core processors, or one or more CISC processors. That is, even though a singular term “a processor” is used herein to refer to processor 512 and processor 522, each of the processor 512 and processor 522 may include multiple processors in some implementations and a single processor in other implementations in accordance with the present disclosure. In another aspect, each of the processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and processor 522 is a special-purpose machine specifically designed, arranged and configured to perform specific tasks in a device (e.g., as represented by communication apparatus 510) and a network (e.g., as represented by network apparatus 520) in accordance with various implementations of the present disclosure.

In some implementations, communication apparatus 510 may also include a memory 514 coupled to processor 512 and capable of being accessed by processor 512 and storing data therein. In some implementations, communication apparatus 510 may further include a transceiver 516 coupled to processor 512 and capable of wirelessly transmitting and receiving data.

In some implementations, network apparatus 520 may further include a memory 524 coupled to processor 522 and capable of being accessed by processor 522 and storing data therein, and a transceiver 526 coupled to processor 522 and capable of wirelessly transmitting and receiving data. Accordingly, communication apparatus 510 and network apparatus 520 may wirelessly communicate with each other via transceiver 516 and transceiver 526, respectively.

For illustrative purposes and without limitation, descriptions of capabilities of the communication apparatus 510 and network apparatus 520 are provided below with process 600 and process 700. In which, communication apparatus 510 is implemented in or as a communication apparatus or a UE, and network apparatus 520 is implemented in or as a network node of a communication network (e.g., a base station).

### Illustrative Processes

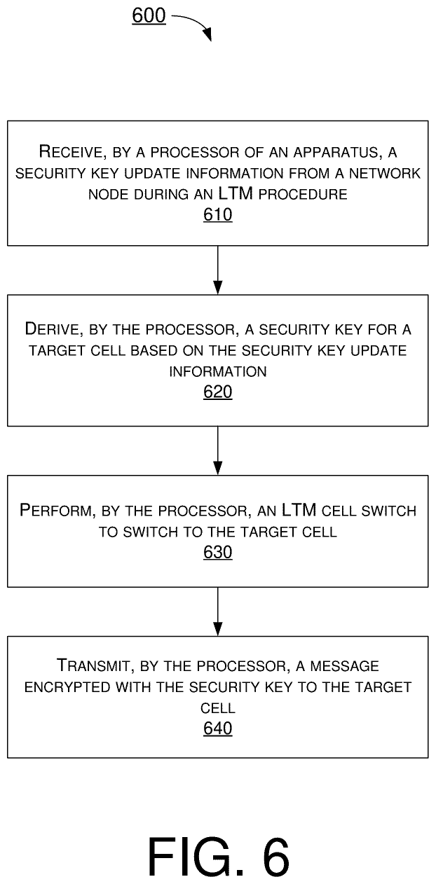

FIG. 6 illustrates an example process 600 in accordance with an implementation of the present disclosure. Process 600 may be an example implementation of above scenarios/schemes, whether partially or completely, with respect to security key derivation for LTM in mobile communications. Process 600 may represent an aspect of implementation of features of communication apparatus 510. Process 600 may include one or more operations, actions, or functions as illustrated by one or more of blocks 610, 620, 630, and 640. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510 as a UE. Process 600 may begin at block 610.

At block 610, process 600 may involve processor 512 of communication apparatus 510 receiving, via transceiver 516, a security key update information from a network node (e.g., network apparatus 520) during an LTM procedure. Process 600 may proceed from block 610 to block 620.

At block 620, process 600 may involve processor 512 deriving a security key for a target cell based on the security key update information. Process 600 may proceed from block 620 to block 630.

At block 630, process 600 may involve processor 512 performing an LTM cell switch to switch to the target cell. Process 600 may proceed from block 630 to block 640.

At block 640, process 600 may involve processor 512 transmitting, via transceiver 516, a message encrypted with the security key to the target cell.

In some implementations, the security key update information is carried by an RRC message received during an LTM preparation stage.

In some implementations, the security key update information is carried by an LTM cell switch command.

In some implementations, the LTM cell switch command is carried by a MAC-CE message.

In some implementations, the security key update information is received before receiving an LTM cell switch command.

In some implementations, the security key update information is carried by a MAC-CE message different from the LTM cell switch command or is indicated by a DCI format.

In some implementations, the security key update information comprises an NCC value. Process 600 may further involve processor 512 deriving the security key for the target cell based on the NCC value and a target cell identifier.

In some implementations, the security key update information comprises an NCC associated information. Process 600 may further involve processor 512 deriving an NCC value based on the NCC associated information. Furthermore, process 600 may also involve processor 512 deriving the security key for the target cell based on the NCC value and a target cell identifier.

In some implementations, the NCC associated information may include an NCC increment indicator.

In some implementations, the NCC associated information may include a difference between the NCC value and a second NCC value.

In some implementations, the second NCC value may include a previous NCC value maintained in communication apparatus 510.

In some implementations, the NCC associated information may include a parameter of a formula for deriving the NCC value.

In some implementations, process 600 may further involve processor 512 storing the security key or an intermediate data generated during deriving the security key.

In some implementations, the security key update information is for a security key derivation process for a next LTM cell switch.

In some implementations, the security key update information is for a vertical key derivation process. Process 600 may further involve processor 512 performing a horizontal key derivation process to derive the security key in an event that the security key update information is absent.

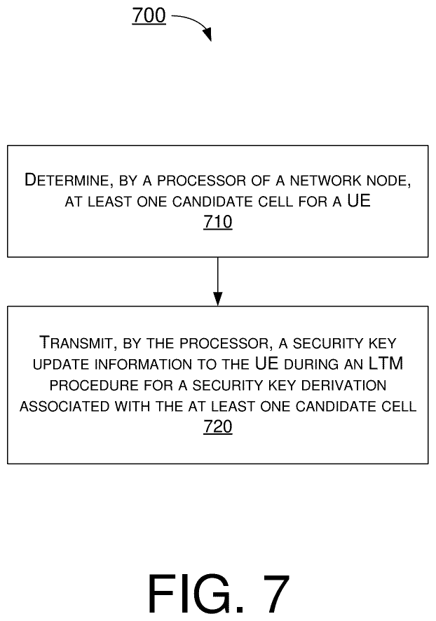

FIG. 7 illustrates an example process 700 in accordance with an implementation of the present disclosure. Process 700 may be an example implementation of above scenarios/schemes, whether partially or completely, with respect to security key derivation for LTM in mobile communications. Process 700 may represent an aspect of implementation of features of network apparatus 520. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any base stations or network nodes. Solely for illustrative purposes and without limitation, process 700 is described below in the context of network apparatus 520. Process 700 may begin at block 710.

At block 710, process 700 may involve processor 522 of network apparatus 520 determining at least one candidate cell for a UE (e.g., communication apparatus 510). Process 700 may proceed from block 710 to block 720.

At block 720, process 700 may involve processor 522 transmitting, via transceiver 526, a security key update information to the UE during an LTM procedure for a security key derivation associated with the at least one candidate cell.

In some implementations, the security key update information is transmitted, via transceiver 526, during an LTM preparation stage.

In some implementations, the security key update information is carried by an LTM cell switch command.

In some implementations, the security key update information may include an NCC value or an NCC associated information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a security key update information from a network node during a layer1/layer2 triggered mobility (LTM) procedure;
deriving, by the processor, a security key for a target cell based on the security key update information;
performing, by the processor, an LTM cell switch to switch to the target cell; and
transmitting, by the processor, a message encrypted with the security key to the target cell.

2. The method of claim 1, wherein the security key update information is carried by a radio resource control (RRC) message received during an LTM preparation stage.

3. The method of claim 1, wherein the security key update information is carried by an LTM cell switch command.

4. The method of claim 1, wherein the security key update information is received before receiving an LTM cell switch command.

5. The method of claim 4, wherein the security key update information is carried by a medium access control (MAC)-control element (CE) message different from the LTM cell switch command or is indicated by a downlink control information (DCI) format.

6. The method of claim 1, wherein the security key update information comprises a next hop chaining counter (NCC) value, and the method further comprises:
deriving, by the processor, the security key for the target cell based on the NCC value and a target cell identifier.

7. The method of claim 1, wherein the security key update information comprises a next hop chaining counter (NCC) associated information, and the method further comprises:
deriving, by the processor, an NCC value based on the NCC associated information; and
deriving, by the processor, the security key for the target cell based on the NCC value and a target cell identifier.

8. The method of claim 7, wherein the NCC associated information comprises:
an NCC increment indicator;
a difference between the NCC value and a second NCC value; or
a parameter of a formula for deriving the NCC value.

9. The method of claim 8, wherein the second NCC value comprises a previous NCC value maintained in the apparatus.

10. The method of claim 1, further comprising:
storing, by the processor, the security key or an intermediate data generated during deriving the security key.

11. The method of claim 1, wherein the security key update information is for a security key derivation process for a next LTM cell switch.

12. The method of claim 1, wherein the security key update information is for a vertical key derivation process, and the method further comprises:
performing, by the processor, a horizontal key derivation process to derive the security key in an event that the security key update information is absent.

13. An apparatus, comprising:
a transceiver which, during operation, communicates wirelessly; and
a processor communicatively coupled to the transceiver such that, during operation, the processor performs operations comprising:
receiving, via the transceiver, a security key update information from a network node during a layer1/layer2 triggered mobility (LTM) procedure;
deriving a security key for a target cell based on the security key update information;
performing an LTM cell switch to switch to the target cell; and
transmitting, via the transceiver, a message encrypted with the security key to the target cell.

14. The apparatus of claim 13, wherein the security key update information is carried by a radio resource control (RRC) message received during an LTM preparation stage.

15. The apparatus of claim 13, wherein the security key update information is carried by an LTM cell switch command.

16. The apparatus of claim 13, wherein the security key update information comprises a next hop chaining counter (NCC) value, and during operation, the processor further performs operations comprising:
deriving the security key for the target cell based on the NCC value and a target cell identifier.

17. The apparatus of claim 13, wherein the security key update information comprises a next hop chaining counter (NCC) associated information, and during operation, the processor further performs operations comprising:
deriving an NCC value based on the NCC associated information; and
deriving the security key for the target cell based on the NCC value and a target cell identifier,
wherein the NCC associated information comprises:
an NCC increment indicator;
a difference between the NCC value and a second NCC value; or
a parameter of a formula for deriving the NCC value.

18. The apparatus of claim 13, wherein the security key update information is for a vertical key derivation process, and during operation, the processor further performs operations comprising:
performing a horizontal key derivation process to derive the security key in an event that the security key update information is absent.

19. A method, comprising:
determining, by a processor of a network node, at least one candidate cell for a user equipment (UE); and
transmitting, by the processor, a security key update information to the UE during a layer1/layer2 triggered mobility (LTM) procedure for a security key derivation associated with the at least one candidate cell.

20. The method of claim 19, wherein:
the security key update information is transmitted during an LTM preparation stage or is carried by an LTM cell switch command; or
the security key update information comprises a next hop chaining counter (NCC) value or an NCC associated information.
